(19) United States
(12) Patent Application Publication
(10) Pub. No.: US 2014/0079901 A1
(43) Pub. Date: Mar. 20, 2014

(54) DECORATIVE LAMINATE PAD FOR SUPPORTING AN ITEM OF FURNITURE

(71) Applicant: Anji Mountain, St. Louis, MO (US)

(72) Inventor: Darryl S. Gold, St. Louis, MO (US)

(73) Assignee: Anji Mountain, St. Louis, MO (US)

(21) Appl. No.: 14/028,206

(22) Filed: Sep. 16, 2013

Related U.S. Application Data
(60) Provisional application No. 61/743,928, filed on Sep. 14, 2012.

(51) Int. Cl. B44F 5/00; B32B 3/10; B32B 3/18; B44C 3/12

(52) U.S. Cl. CPC B44F 5/00; B44C 3/12; B32B 3/10; B32B 3/18
USPC 428/61; 156/148; 156/304.1; 428/102

(57) ABSTRACT

A decorative laminate pad for supporting an item of furniture including a rigid plank having a top surface, bottom surface, and peripheral edge. An ornamental sheet substantially covers the top surface of the rigid plank. The ornamental sheet has a thickness. An adhesive layer is disposed between the top surface of the rigid plank and the ornamental sheet to adhere the ornamental sheet to the rigid plank. A backing layer is adhered to the bottom surface, and a decorative thread is stitched into the decorative laminate pad. The decorative thread passes through the thickness of the ornamental sheet and does not enter the backing layer.

### BACKGROUND

The present invention generally relates to underlying support pads used to support furniture and the like upon a surface, and more particularly, to a decorative chair pad with a decorative top surface laminated to a rigid substrate. Chair pads are well known furnishings frequently used in an office environment to support wheeled desk chairs on a free-rolling surface. Occasionally, such pads are used in offices to support chairs without wheeled feet or in other environments to support other types of furniture. In many instances, the pads have a low-resistance top surface to facilitate uninhibited translation across the surface.

For this reason, most support pads currently on the market are formed of a one-piece slab of plastic material. The pads known in the art are typically very thin and flexible, so they can be rolled up when not in use. However, these pads lack aesthetic appeal. Accordingly, a chair pad that can support an item of furniture while maintaining aesthetic appeal is desired.

### SUMMARY

In one aspect, the present invention includes a decorative laminate pad for supporting an item of furniture. The decorative laminate pad comprises a rigid plank. The rigid plank comprises a top surface, a bottom surface, and a peripheral edge. An ornamental sheet substantially covers the top surface of the rigid plank. The ornamental sheet has a thickness. An adhesive layer is disposed between the top surface of the rigid plank and the ornamental sheet to adhere the ornamental sheet to the rigid plank. A backing layer is adhered to the bottom surface, and a decorative thread is stitched into the decorative laminate pad. The decorative thread passes through the thickness of the ornamental sheet and does not enter the backing layer.

In another aspect of the invention, a method of making a decorative laminate pad for supporting an item of furniture comprises: (a) providing a rigid plank comprising a top surface and a bottom surface; (b) providing an ornamental sheet of flexible material for substantially covering the top surface of the rigid plank; the ornamental sheet has a thickness; (c) disposing a first adhesive layer between the top surface of the rigid plank and the ornamental sheet; (d) adhering the top surface of the rigid plank to the ornamental sheet with the first adhesive layer to form a covered ornamental panel; (e) adhering the bottom surface of the rigid plank to a backing layer; and (f) passing an ornamental thread back and forth through the thickness of the ornamental sheet. The ornamental thread does not enter the backing layer.

In another aspect of the present invention, a decorative laminate pad for supporting an item of furniture comprises rigid planks arranged side-by-side at a junction in a deployed position of the pad in which the planks define a bottom surface. Each plank comprises a top surface. Ornamental sheets of flexible material overlie the top surface of respective ones of the rigid planks. A backing layer substantially covers the bottom surface of the rigid planks and is adhered to said bottom surface across the junction. A first adhesive layer disposed between each of the ornamental sheets and each of the rigid planks. The first adhesive layer does not extend across the at least one junction.

In still another aspect of the present invention, a method of making a decorative laminate pad for supporting an item of furniture comprises: (a) providing rigid planks; each rigid plank includes a top surface; (b) providing ornamental sheets of flexible material; (c) applying a first adhesive to at least one of the top surface of each of the rigid planks and a corresponding one of the ornamental sheets; (d) engaging the ornamental sheets with the rigid planks to form covered ornamental panels; (e) arranging the covered ornamental panels side-by-side in a deployed position, the arranged covered ornamental panels comprising a bottom surface and a junction; and, (f) adhering a backing layer to said bottom surface across the junction.

Other aspects of the present invention will be apparent in view of the following description and claims.

### BRIEF DESCRIPTION OF THE DRAWINGS

FIG. 1 is a perspective of a decorative laminate pad shown in a deployed position with a rolling office chair supported thereupon.

FIG. 2 is a top plan view of the decorative laminate pad of FIG. 1 shown in a deployed position.

FIG. 3 is a perspective of the decorative laminate pad of FIG. 1 shown in a transitional position between a folded position and a deployed position.

FIG. 4 is an enlarged fragmentary section view of the decorative laminate pad of FIG. 1 taken in the plane including line 4-4 in FIG. 1.

FIG. 5 is an enlarged fragmentary perspective of a corner of the decorative laminate pad of FIG. 1.

FIG. 6 is an enlarged fragmentary section of the decorative laminate pad of FIG. 1 taken in the plane including line 6-6 of FIG. 5.

FIG. 7 is an enlarged fragmentary section of an alternative embodiment of the decorative laminate pad of FIG. 1 taken in the plane including line 7-7 of FIG. 5.

Corresponding reference characters indicate corresponding parts throughout the drawings.

### DETAILED DESCRIPTION OF THE DRAWINGS

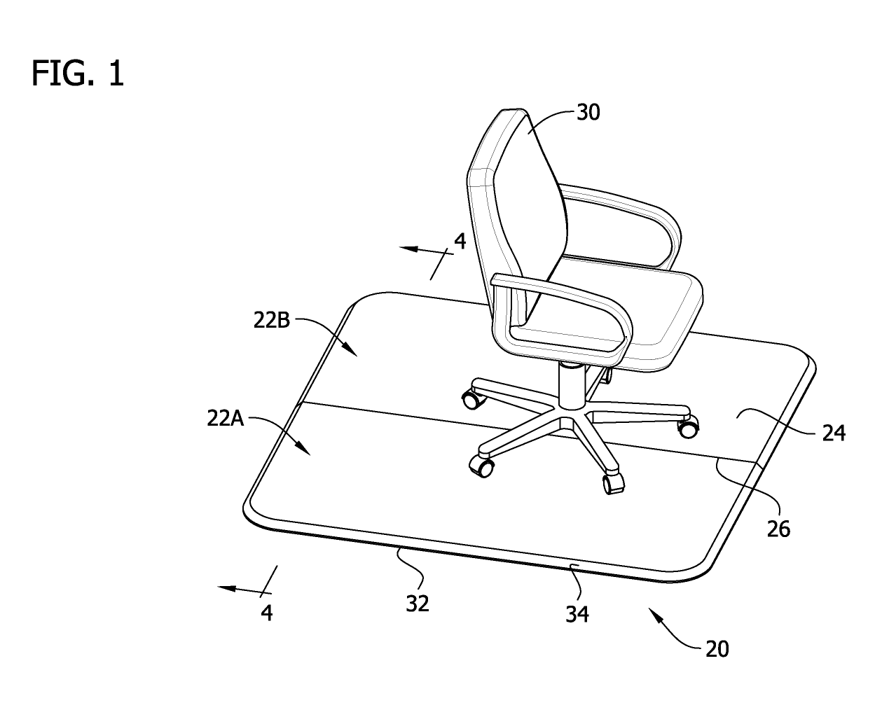

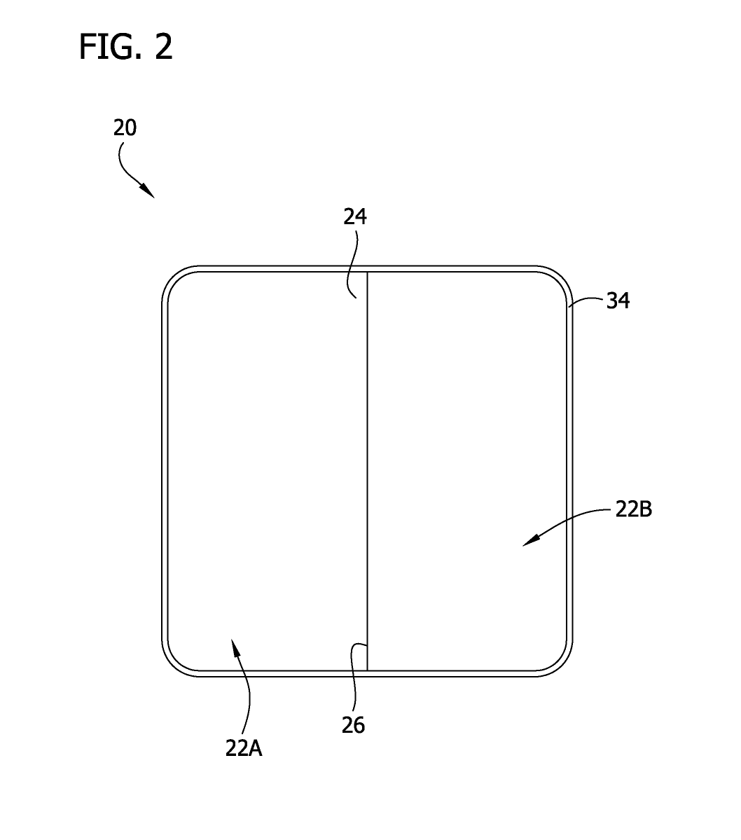

Referring to FIGS. 1 and 2, a decorative laminate support pad of a first embodiment of the present invention is designated in its entirety by the reference number 20. The illustrated pad 20 includes two panels 22A-B foldably assembled to create an aesthetically pleasing top surface 24. As will be understood, chair pads that include one or more than two panels may also be used without departing from the scope of the invention. In the illustrated embodiment, the top surface 24 includes top surface of panels 22A-B. The top surface further includes a seam 26 where panel 22A meets panel 22B. For embodiments having more than two panels, the top surface will have more seams in accordance with the principles set out here. As shown in FIG. 1, the top surface 24 supports a chair 30 such as the illustrated rolling office chair. Alternatively, the top surface 24 may support any other type of furniture or other item in need of underlying support. In some embodiments, the top surface 24 is a low-resistance surface. Such a low resistance surface may permit the chair 30 or other item to roll or otherwise translate thereacross without obstruction. Preferably, the seam 26 does not hinder the translation.

The pad 20 also includes a bottom surface 32. In some embodiments, the bottom surface 32 is a high resistance surface to prevent the pad 20 from moving laterally with respect to the surface on which it is placed (e.g., the floor or the ground). In certain embodiments, the bottom surface 32 may have a non-uniform profile to resist lateral movement with respect to a carpeted surface disposed therebeneath. The illustrated pad 20 also includes a beveled edge 34 that provides a smooth transition between the top surface 24 and the surface on which the pad sits. The beveled edge 34 allows the chair 30 or other item to be rolled or otherwise translated across a boundary between the pad 20 and another surface without catching on the boundary.

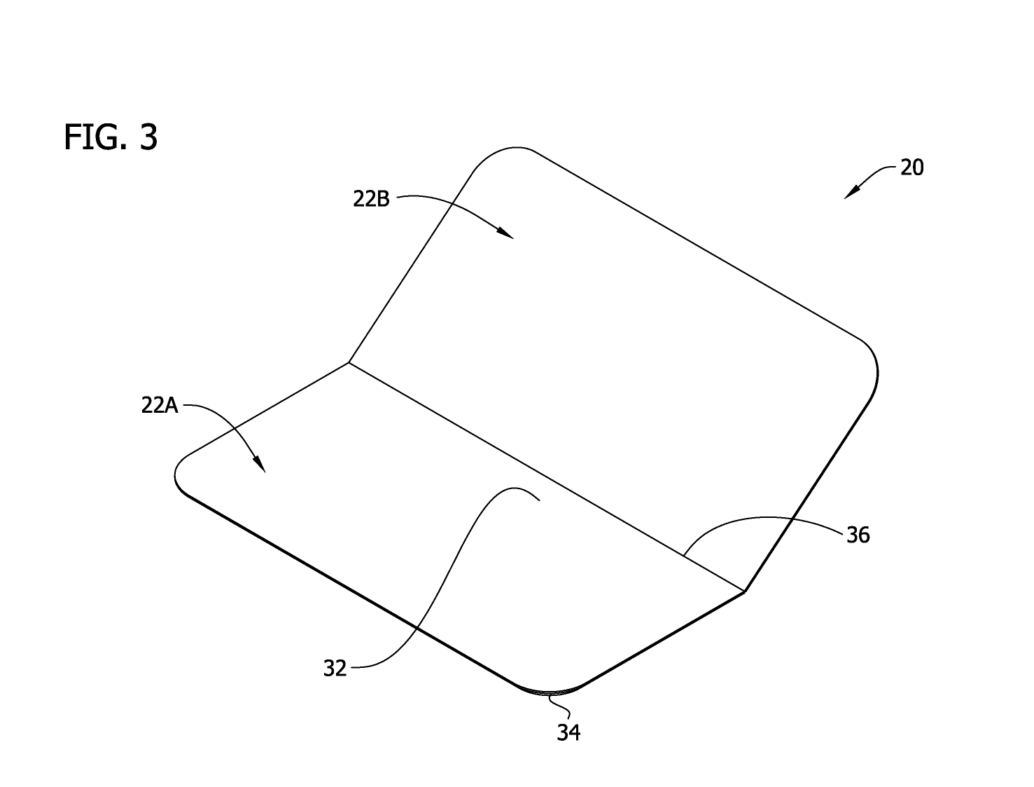

Turning now to FIG. 3, the chair pad 20 is shown with its bottom surface 32 oriented up. In the illustrated embodiment, a hinged structure 36 hingedly secures panel 22A with panel 22B. Embodiments of the decorative pad having more than two panels may suitably include more than one hinge structure to permit folding or rolling of the plurality of panels. The hinged structure 36 permits the pad 20 to be folded into a more manageable size for transport and storage. Thus the illustrated pad 20, can hingedly transition between two positions, a flat, deployed position (FIGS. 1 and 2) and a folded position (not shown). In the deployed position, one longitudinal edge of panel 22A abuts a respective longitudinal edge of panel 22B such that the panels form a substantially uniform top surface 24. In the folded position, the bottom surface 32 lies adjacent to itself such that the portion of the bottom surface beneath the panel 22A lies adjacent to the portion of bottom surface beneath 22B. As would be understood by one skilled in the art, many different hinge mechanisms may be used for the structure 36A without departing from the scope of the present invention, but one preferred embodiment will be discussed in more detail below. Any of the hinge structures usable in the illustrated two-panel configuration may also be used in any other multi-panel configuration without departing from the scope of the invention.

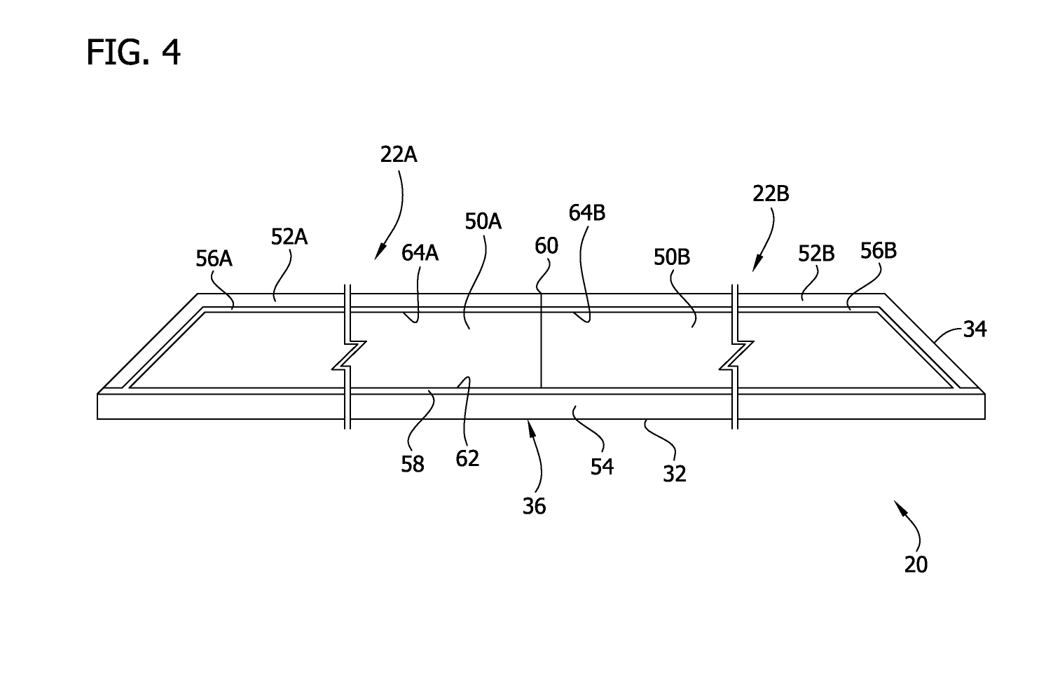

In one exemplary embodiment shown in FIG. 4, each of the panels 22A-B includes a substrate or plank layer 50A-B, decorative top layer 52A-B, a backing layer 54, a first adhesive layer 56A-B, and a second adhesive layer 58. The planks 50A-B are preferably made of a strong, rigid material such as medium density fiberboard or high density fiberboard. The planks 50A-B may also be made from any other suitable substrate material such as, by way of example only, cork, wood, natural latex, rubber, or other suitable polymer. In the illustrated embodiment in which the pad 20 is disposed in the deployed position, rigid planks 50A and 50B are arranged side-by-side at a junction 60. It should be understood that pad embodiments having more than two panels may include more than one junction. Together, the planks define an essentially uniform bottom surface 62 extending across the bottom of each of the planks 50A-B and the junction 60.

Each of the panels 22A-B includes an ornamental sheet of flexible material 52A-B, respectively. Preferably the ornamental sheets 52A-B are made from a material that gives top surface 24 a decorative, aesthetically pleasing appearance. In some embodiments, the ornamental sheet of flexible material is made from leather material, vinyl, or cork board. Leather in all forms, including natural leather, bonded leather, leather board, and synthetic leather may be broadly considered “leather material.” However, other flexible materials may also be used without departing from the scope of the invention. In the illustrated embodiment, ornamental sheets 52A-B overlie the top surfaces 64A-B of each of the rigid planks 50A-B as a laminate thereupon. In preferred embodiments, a single respective one-piece decorative sheet 52A-B overlies each corresponding single one-piece rigid plank 50A-B. This combination desirably gives the pad 20 the strength of the rigid planks 50A-B while maintaining the aesthetic beauty of the decorative ornamental sheets 52A-B.

A backing layer 54 substantially covers the bottom surface 62 of the rigid planks 50A-B. In the illustrated embodiment the backing layer 54 is adhered to planks 50A-B across the junction 60. Preferably, the backing layer 54 is made from a high-resistance material that grips the surface it sits on to resist lateral movement with respect thereto. In one preferred embodiment, the backing layer 54 is formed from a sheet of latex cut to extend slightly beyond the perimeter of the bottom surface of the planks 62. Other materials, sizes, and manufacturing methods may also be used without departing from the scope of the present invention. Preferably, the backing layer 54 is formed of a wear-resistant, flexible material to function as a hinge at hinge structures 36. When such a backing layer material is chosen, no other hinge structure is required to facilitate transitioning the pad 20 between its deployed and folded positions. For added strength, a layer of mesh tape (not shown) may be placed along the length of the junction 60 on the bottom surface 62 of the planks 50A-B.

To sustain the abuse of an office chair or other item frequently rolling or otherwise translating across the top surface of the chair pad 20, the decorative layers 52A-B must be properly secured to their respective rigid planks 50A-B. In one embodiment, a first adhesive layer 56A-B is disposed between each of the ornamental sheets 52A-B and each of the corresponding planks 50A-B. As shown in FIG. 4, the adhesive layers 56A-B do not extend across the junction 60. As a result, the adhesive layers 56A-B do not interfere with the pad 20 being folded into a folded position. One material suitable for use as the adhesive layers 56A-B is Fevicol SR 505 Synthetic Rubber Adhesive, which can create a strong bond between the decorative sheets 52A-B and planks 50A-B without the need for heat treatment. The process of securely attaching the decorative layers 52A-B to the planks 50A-B will be discussed in greater detail below.

The backing layer 54 must also be strongly attached to the rigid planks 50A-B on their bottom surface 62. In the illustrated embodiment, the same adhesive material is used to adhere the planks 50A-B to both the decorative sheets 52A-B and the backing layer 54. However, the same adhesive need not be used for both surfaces. Any adhesive known in the art may be used to attach the backing layer 62 to the rigid planks 50A-B without departing from the scope of the invention. In addition, other forms of connection including heat, pressure, and mechanical fasteners may also be used to attach the backing layer 62.

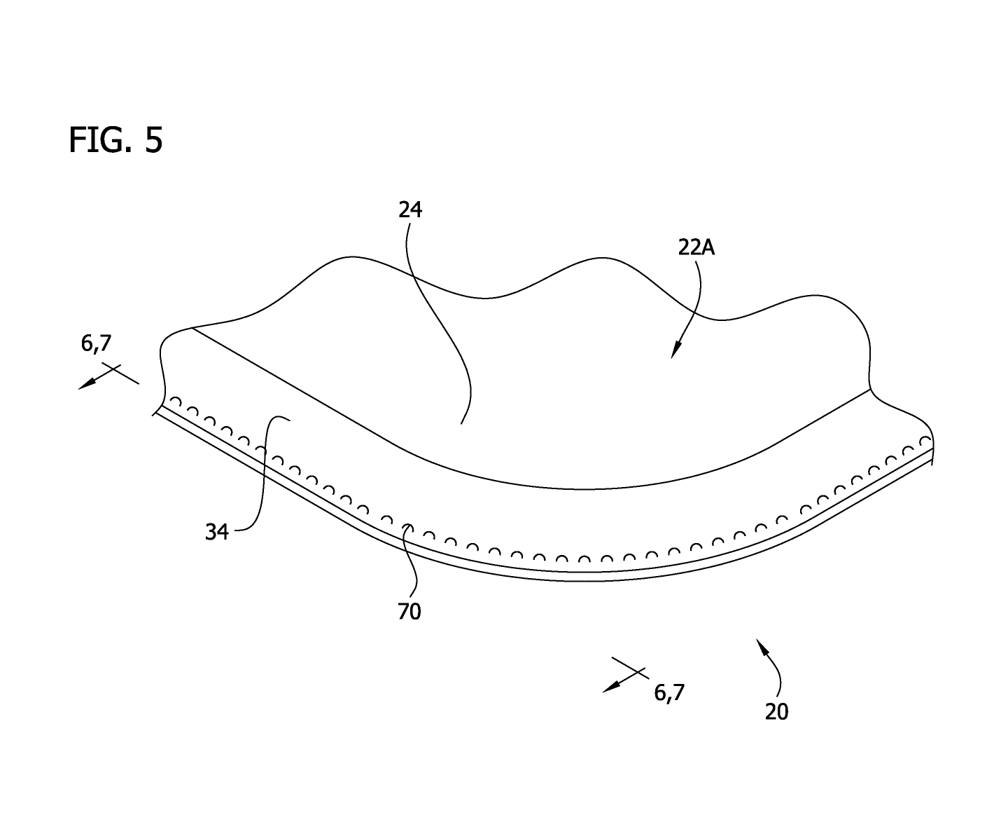

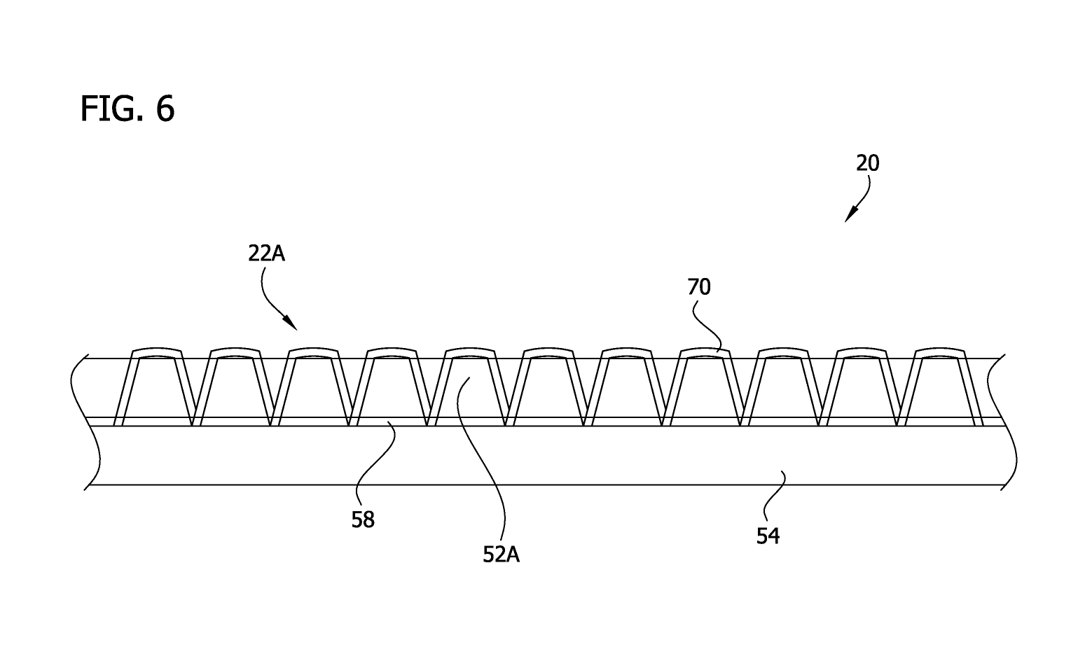

Turning now to FIGS. 5-6, a decorative thread 70 is stitched into the chair pad 20 in an ornamental pattern. It is well know in the art of decorative furnishings, that a well-placed stitching pattern can greatly improve the aesthetic appeal of an item by providing contrast or texture to a surface while maintaining an appearance of utility. Commonly, such decorative patterns are placed near borders or seams. Border stitching is fraught with challenges when applied to the decorative laminate pad 20 described above. In particular, it would be very difficult and labor intensive to stitch a decorative thread through the planks 50A-B due to their strength and rigidity. To overcome this limitation, in the illustrated embodiment (shown best in FIG. 4), the edges of the decorative sheets 52A-B extend past the edges of the bottom surface of the rigid planks 62. Likewise, the backing layer 54 extends beyond the edges of the bottom surface 62 where its edges are adhered directly to the edges of the decorative sheets 52A-B. Although the edges of the decorative sheets 52A-B could be stitched to the backing layer 54, doing so causes the edges of the backing layer to pull up away from the surface on which the pad 20 is sitting. This disrupts the smooth transition between the ground and the pad 20 provided by the beveling 34. It is believed that because leather is stretched in plane when attached, it has a stressed condition. If the attached mechanically as by stitching to the backing layer, the relief of that stress causes the edges to roll up. However, the adhesive allows stress relief without rolling up the edge because relative movement is permitted.

As shown best in FIGS. 5-7, this concern is addressed in certain embodiments of a decorative pad 20 of the present invention. Although this aspect of the invention is only discussed in terms of a single panel 22A, the description also applies to the panel 22B or additional panels in other multi-panel embodiments according to the principles discussed here. Likewise, it should be understood that the principles discussed here may be applied with equal effectiveness to a decorative pad having only one panel. In the illustrated embodiment of FIG. 6, a decorative thread 70 is stitched into the decorative pad 20, but does not cause the backing layer 54 to pull up away from the surface on which the pad sits. The decorative thread 70 passes through the thickness of the ornamental sheet 52A and does not enter the backing layer 54 (or the rigid plank 50A). The decorative thread 70 is suitably positioned on the pad 20 such that it overlies only the backing layer 54 and not the plank 50A.

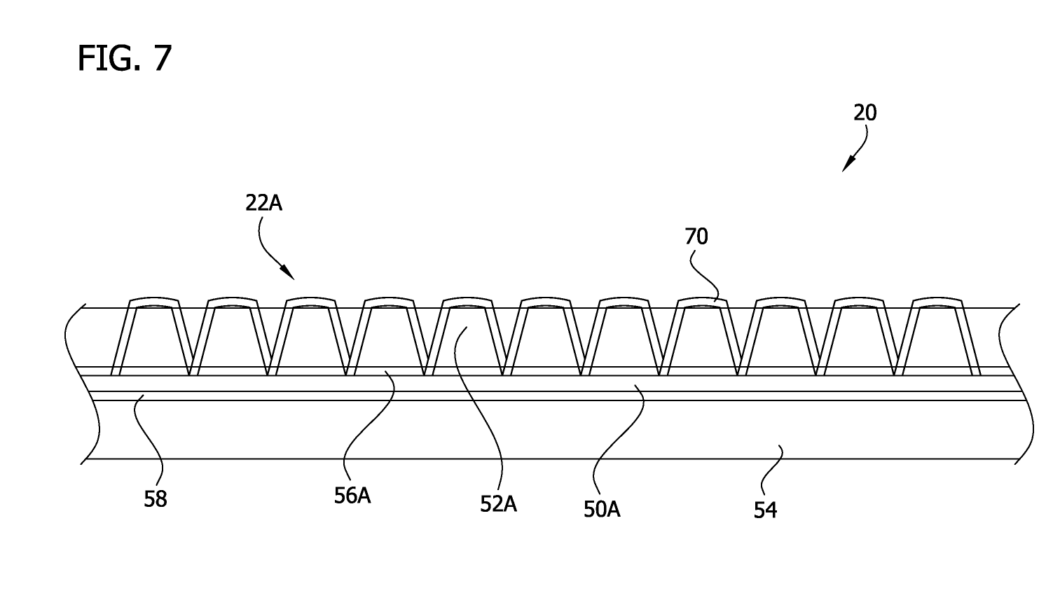

However, the same principles can be applied to provide decorative stitching to a portion of the decorative sheet 52A that overlies the rigid plank 50A. For example, in the embodiment illustrated in FIG. 7, the decorative thread 70 passes through the thickness of the ornamental sheet 52A and does not enter the rigid plank 50A even though the peripheral edge of the rigid plank is generally aligned with the edge portion of the ornamental sheet. The thread 70 may be stitched in any desired pattern without departing from the scope of the present invention. In some embodiments, a nylon thread is used, but other thread types may be used as well.

One process for making a decorative laminate pad for supporting an item of furniture according to the principles of the present invention includes providing rigid planks 50A-B of a desired size. The planks 50A-B may be cut from a larger sheet of substrate material or they may be simply purchased in a desired size. The ornamental sheets 52A-B are also provided in a size for substantially covering the top surfaces of the rigid planks 50A-B. In some embodiments, the ornamental sheets 52A-B are cut from a larger roll or sheet of decorative material. In other embodiments, the sheets 50A-B may be otherwise formed to the desired size, as by molding or other known processes. Preferably, the pad-exterior edges of the planks 50A-B are skived at a desired bevel angle. In some embodiments, the pad-exterior edges of the planks 50A-B are skived to a point along a two-inch border of the pad. In other embodiments, they are skived to leave a slight plank thickness, in the range of about 1/16 inches to about ⅛ inches, at the pad edges of planks 50A-B. In some embodiments, the pad corners of the planks 50A and 50B may be rounded, for example, at a twelve-inch diameter. In other embodiments, the planks 50A-B may have rectilinear corners.

The plank-adjacent surfaces of the sheets 52A-B may be cleaned and tested for moisture content. Likewise, the planks 50A-B may be cleaned and sanded. If a decorative stitching pattern is desired, the ornamental thread 70 may be stitched through the decorative sheets 52A-B before they are adhered to the planks 50A-B. Preferably, the decorative thread 70 is not stitched through either the planks 50A-B or the backing layer 54, as discussed above. Once the planks 50A-B and decorative sheets 52A-B are prepared, a thin layer of adhesive (such as SR 505 adhesive) may be applied to the top surfaces of each of the planks 50A-B and to the plank-adjacent surfaces of each of the decorative sheets 52A-B. Once the adhesive is applied to the planks 50A-B and decorative sheets 52A-B, the adhesive is allowed to cure for a period of time, in some embodiments ten minutes. The decorative sheets 52A-B are then placed on their respective planks 50A-B such that the two thin layers of adhesive applied earlier bond to form a single first adhesive layer 56A-B for each panel 22A-B respectively. At this point, a pressure may be applied across the top and bottom surfaces of each of the panels 22A-B for a desired period of time. In some embodiments, 50 psi of pressure is applied for a period of 15 minutes.

The panels 22A-B should be arranged side-by-side at junction 60. In some embodiments, the panels 22A-B are arranged in a mold that holds each in proper alignment with the others. The bottom surface 62 of the planks 50A-B should be adhered to the backing layer 54. In one method of adhering the bottom surface 62 to the backing layer 54, a thin layer of adhesive is applied separately to the plank-bottom surface and backing layer respectively and allowed to cure until just tacky. At that point, the arranged panels 22A-B are aligned with the backing layer, and the two thin layers of adhesive combine to create a second single adhesive layer 58. Pressure is applied to the broad surfaces of the top surface 24 and bottom surface 30 of the now-assembled (but not yet completed) pad 20 for a period of time. In one preferred embodiment a pressure of 350 psi is applied to the pad 20 for a period of one hour. Thereafter, the pad 20 is cleaned with a damp cloth from any residue or marks that may have come about during processing.

Although the above-described method relied on an adhesive that cures under ambient temperature conditions, it should be understood that the application of a heat-cured adhesive does not depart from the scope of the invention.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A decorative laminate pad for supporting an item of furniture comprising:
a rigid plank comprising a top surface, a bottom surface, and a peripheral edge;
an ornamental sheet substantially covering the top surface of the rigid plank, the ornamental sheet having a thickness;
an adhesive layer disposed between the top surface of the rigid plank and the ornamental sheet to adhere the ornamental sheet to the rigid plank;
a backing layer adhered to the bottom surface; and
a decorative thread stitched into the decorative laminate pad, wherein the decorative thread passes through the thickness of the ornamental sheet and does not enter the rigid plank or the backing layer.

2. The decorative laminate pad of claim 1 wherein the ornamental sheet includes an edge portion extending beyond the peripheral edge, the stitching being disposed in the edge portion.

3. The decorative laminate pad of claim 2 wherein the backing layer includes an edge portion extending beyond the peripheral edge of the plank.

4. The decorative laminate pad of claim 3 further comprising adhesive attaching the edge portion of the ornamental sheet to the edge portion of the backing layer.

5. The decorative laminate pad of claim 1 wherein the ornamental sheet includes an edge portion generally aligned with the peripheral edge of the rigid plank, the stitching being disposed in the edge portion.

6. The decorative laminate pad of claim 1 wherein the rigid plank comprises a plurality of rigid planks arranged side-by-side at a junction in a deployed position of the pad in which the planks define said bottom surface, and said top surface comprises a top surface of each plank.

7. The decorative laminate pad of claim 6 wherein the ornamental sheet comprises a plurality of ornamental sheets, each of the ornamental sheets corresponding with of a corresponding top surface of one of the plurality of rigid planks.

8. The decorative laminate pad of claim 7 wherein the first adhesive layer does not extend across the junction.

9. The decorative laminate pad of claim 1 wherein the ornamental sheet comprises leather.

10. The decorative laminate pad of claim 1 wherein the ornamental sheet comprises leather board.

11. A method of making a decorative laminate pad for supporting an item of furniture, the method comprising:
(a) providing a rigid plank comprising a top surface and a bottom surface;
(b) providing an ornamental sheet of flexible material for substantially covering the top surface of the rigid plank, the ornamental sheet having a thickness;
(c) disposing a first adhesive layer between the top surface of the rigid plank and the ornamental sheet;
(d) adhering the top surface of the rigid plank to the ornamental sheet with the first adhesive layer to form a covered ornamental panel;
(e) adhering the bottom surface of the rigid plank to a backing layer; and
(f) passing an ornamental thread back and forth through the thickness of the ornamental sheet, wherein the ornamental thread does not enter the backing layer.

12. The method of claim 11 wherein:
step (a) further comprises providing a plurality of rigid planks, each of the plurality of rigid planks comprising a top surface and a bottom surface;
step (b) further comprises providing an ornamental sheet of flexible material for each plank, the ornamental sheet covering the top surface the respective plank;
step (c) further comprises disposing a layer between the top surface of each of the plurality of rigid planks and a corresponding one of the plurality of ornamental sheets;
step (d) further comprises adhering the top surface of each of the plurality of rigid planks to the corresponding one of the plurality of ornamental sheets with the first adhesive layer to form a plurality of covered ornamental panels;
step (e) further comprising adhering the bottom surface of the plurality of rigid planks to the backing layer;
step (f) further comprises passing the decorative thread through at least one of the plurality of ornamental sheets, wherein the decorative thread does not enter the backing layer.

13. A method of making a decorative laminate pad for supporting an item of furniture, the method comprising:
(a) providing rigid planks, each rigid plank including a top surface;
(b) providing ornamental sheets of flexible material;
(c) applying a first adhesive to at least one of the top surface of each of the rigid planks and a corresponding one of the ornamental sheets;
(d) engaging the ornamental sheets with the rigid planks to form covered ornamental panels;
(e) arranging the covered ornamental panels side-by-side in a deployed position, the arranged covered ornamental panels comprising a bottom surface and a junction; and,
(f) adhering a backing layer to said bottom surface across the junction.

14. The method of claim 13 wherein step (c) further comprises:
applying a first coating of adhesive to the top surface of each of the rigid planks;
applying a second coating of adhesive to each of the plurality of ornamental sheets; and,
permitting the first and second coatings of adhesives to cure for a first period of time before performing step (d).

15. The method of claim 14 wherein step (e) further comprises applying pressure to each of the plurality of covered ornamental panels for a second period of time.

16. The method of claim 15 wherein step (f) further comprises:
forming a backing layer sized to cover the bottom surface of the covered ornamental panels;
disposing a second adhesive layer between said bottom surface and the backing layer; and,
applying pressure to the decorative laminate pad for a third period of time.

17. The method of claim 16 wherein step (e) further comprises applying pressure to the decorative laminate pad for the third period of time.

18. The method of claim 13 further comprising passing a decorative thread through at least one of the ornamental sheets, wherein the decorative thread does not enter the rigid planks or the backing layer.
